(19) United States
(12) Patent Application Publication
(10) Pub. No.: US 2005/0285537 A1
(43) Pub. Date: Dec. 29, 2005

(54) Fluorescent lamp

(76) Inventors: Fumihiro Inagaki, Otokuni-gun (JP); Masaaki Hama, Muko-shi (JP)

Correspondence Address: SNELL & WILMER L.L.P.;Attn: Joseph W. Price, Esq., Suite 1200, 1920 Main Street, Irvine, CA, 92614-7230, US

(21) Appl. No.: 11/165,396

(22) Filed: Jun. 23, 2005

(30) Foreign Application Priority Data
Jun. 29, 2004 (JP) 2004-192151
Jun. 3, 2005 (JP) 2005-164073

(51) Int. Cl. H01J 65/04

(52) U.S. Cl. 313/635; 313/639

(57) ABSTRACT

The present invention provides a fluorescent lamp, comprising: a glass bulb; mercury that is enclosed within the glass bulb, an amount of the mercury being from 2.2 μg/cm³ to 8.8 μg/cm³; a rare gas that is enclosed within the glass bulb; an electrode that is attached to the glass bulb; a protective layer that is formed on an inside surface of the glass bulb, and includes metal oxide particles and at least 50 wt % of silica, a thickness of the protective layer being from 0.5 μm to 5.0 μm; and a phosphor layer that is formed over the protective layer.

### CROSS-REFERENCE TO RELATED APPLICATION

This application is based on application NO. 2004-192151 filed in Japan, the contents of which are hereby incorporated by reference.

### BACKGROUND OF THE INVENTION

(1) Field of the Invention

The present invention relates to a fluorescent lamp.

(2) Description of the Related Art

For a fluorescent lamp, mercury is an essential material as a discharge gas and a source of an ultraviolet ray that excites a phosphor. However, the mercury reacts with alkali metal that flows out from the glass bulb, and is gradually inactivated during the lighting (This phenomenon that causes the inactivation is hereinafter called “the mercury consumption”). As a result, the mercury, which contributes to the light emission, runs short. This lowers the luminous flux.

Conventionally, for preventing the reaction of the mercury with the alkali metal, a protective layer is formed between the glass bulb and the phosphor layer. For instance, Japanese Laid-open Patent Application Publication No. 10-125282 discloses a technique for forming a silica protective layer, and Japanese Patent No. 3341443 discloses a technique for forming an alumina protective layer. Meanwhile, it is also conventionally performed that additional mercury is enclosed in advance, in anticipation of the mercury consumption.

However, with increasing awareness of environmental issues in recent years, it has been tried to reduce the amount of the mercury to be enclosed.

As a method for reducing the amount of the mercury to be enclosed, it is possible to thicken the protective layer to effectively prevent the reaction of the mercury with the alkali metal. This method is particularly effective for a fluorescent lamp having a bent glass bulb, such as a ring-shaped fluorescent lamp. This is because the bent glass bulb is formed through a bending process, in which the glass bulb is bent by heat, and this brings the glass bulb into the state in which the alkali metal readily flows out from the glass bulb. This makes the mercury readily react with the alkali metal.

However, if the protective layer is thickened as described above, the protective layer might interfere with the visible light and lower the luminous flux.

Furthermore, if the protective layer is thick, cracks might be caused on the protective layer, and therefore the phosphor layer formed on the protective layer is easily exfoliated. Therefore, if the protective layer is thick, it is difficult to use a material that includes alumina as a primary ingredient for the protective layer, because such a material is not powerfully adhesive to the phosphor layer.

### SUMMARY OF THE INVENTION

In view of the above-described problems, the object of the present invention is to provide a fluorescent lamp having a protective layer that is capable of suppressing the mercury consumption without lowering the luminous flux, and therefore requiring only a smaller amount of mercury to be enclosed.

The above object is fulfilled by a fluorescent lamp, comprising: a glass bulb; mercury that is enclosed within the glass bulb, an amount of the mercury being from 2.2 μg/cm³ to 8.8 μg/cm³; a rare gas that is enclosed within the glass bulb; an electrode that is attached to the glass bulb; a protective layer that is formed on an inside surface of the glass bulb, and includes metal oxide particles and at least 50 wt % of silica, a thickness of the protective layer being from 0.5 μm to 5.0 μm; and a phosphor layer that is formed over the protective layer.

This structure can suppress the mercury consumption without lowering the luminous flux. The fluorescent lamp with the stated structure can achieve the rated life with a small amount of mercury due to the suppressed mercury consumption, and lessen the adverse effect on the environment.

Here, the reason why the fluorescent Lamp can achieve the rated life with a small amount of mercury is that the thickness of the protective layer is from 0.5 μm to 5.0 μm. This is thicker than the conventional protective layer. The thickened protective layer prevents the reaction of the mercury with the alkali metal, suppresses the mercury consumption, and prevents the luminous flux from being lowered.

Although the protective layer of the fluorescent lamp according to the present invention is thicker than the conventional protective layer, the luminous flux is not lowered. This is because, while the protective layer interferes with the visible light and lowers the luminous flux, the protective layer reflects the ultraviolet rays. As a result, the phosphor layer can use the ultraviolet rays more efficiently and improve the luminous flux.

In addition, only a small amount of an amalgam is generated in the fluorescent lamp according to the present invention, because the reaction of the mercury with the alkali metal is prevented. Accordingly, the fluorescent lamp according to the present invention also has an effect of preventing the generation of black spots and darkening, which are caused on the inside surface of the glass bulb by the amalgam.

Also, as the protective layer is thickened, exfoliation of the phosphor layer is hardly caused even if cracks are caused on the protective layer and the phosphor layer. This is because the protective layer is formed by silica and therefore powerfully adhesive to the phosphor layer. As a result, the luminous flux is not readily lowered, the appearance of the fluorescent lamp is not readily deteriorated, and the production yield is improved.

Furthermore, it is easy to remove the protective layer from the glass bulb because of its thickness, which means that it is easy to remove the protective layer on the sealing part for sealing the both ends of the glass bulb, and it is easy to remove the protective layer from a useless glass bulb for recycling. In addition, the fluorescent lamp according to the present invention does not require investment in facility, because it can be manufactured with existing facilities. Soda-lime glass can be used for manufacturing the glass bulb, just like the conventional glass bulb.

Here, the glass bulb may have a bent shape, and the thickness of the protective layer may be 0.8 μm or more.

In the case where the fluorescent lamp has a bent glass bulb, the mercury is rapidly consumed because the amount of the alkali flowed out from the glass bulb is large. However, the rated life can be achieved by setting the thickness of the protective layer at 0.8 μm or more.

Here, an inside diameter of the glass bulb may be less than 17 mm, and at least 4.4 μg/cm³ of the mercury may be enclosed within the glass bulb.

In the case where the inside diameter of the glass bulb of the fluorescent lamp is less than 17 mm, the mercury is rapidly consumed because the lamp load (the emission power per the inner surface of the lamp) is high. However, the rated life can be achieved by enclosing 4.4 μg/cm³ or more of mercury within the glass bulb.

Here, the protective layer may include yttria.

With the stated structure, the yttria suppresses the mercury consumption of the fluorescent lamp. This realizes a long-life fluorescent lamp.

Here, a BET specific surface of the silica may be from 25 m²/g to 180 m²/g.

With the stated structure, an even protective layer with resistance to the environment can be formed.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 includes a partially cutaway plan view of a ring-shaped fluorescent lamp according to an embodiment of the present invention, and an enlarged schematic cutaway view of the cutaway part;

FIG. 2 is a graph showing how a thickness of a protective layer and an amount of enclosed mercury affect a life of a ring-shaped fluorescent lamp;

FIG. 3 is a table showing how a thickness of a protective layer affects characteristics of the lamp;

FIG. 4 is a table showing how an amount of silica affects characteristics of the lamp;

FIG. 5 is a table showing how a BET specific surface affects characteristics of the protective layer;

FIG. 6 includes a partially cutaway plan view of a twin tube fluorescent lamp according to a modification of the present invention, and an enlarged schematic cutaway view of the cutaway part;

FIG. 7 includes a partially cutaway plan view of a double ring-shaped fluorescent lamp according to a modification of the present invention, and an enlarged schematic cutaway view of the cutaway part;

FIG. 8 includes a partially cutaway plan view of a straight tube fluorescent lamp according to a modification of the present invention, and an enlarged schematic cutaway view of the cutaway part;

FIG. 9 is a graph showing how a thickness of a protective layer and an amount of enclosed mercury affect a life of a straight tube fluorescent lamp;

FIG. 10 includes a partially cutaway plan view of a slim fluorescent lamp according to a modification of the present invention, and an enlarged schematic cutaway view of the cutaway part;

FIG. 11 is a graph showing how a thickness of a protective layer and an amount of enclosed mercury affect a life of the ring-shaped fluorescent lamp, an inside diameter of whose glass bulb is less than 17 mm;

FIG. 12 is a graph showing how a thickness of a protective layer and an amount of enclosed mercury affect a life of a straight tube fluorescent lamp, an inside diameter of whose glass bulb is less than 17 mm; and

FIG. 13 includes a partially cutaway plan view of an electrodeless fluorescent lamp according to a modification of the present invention, and an enlarged schematic cutaway view of the cutaway part.

### DESCRIPTION OF THE PREFERRED EMBODIMENT

The following describes a ring-shaped fluorescent lamp according to a preferred embodiment of the present invention, with reference to the figures.

(1) Structure of Fluorescent Lamp

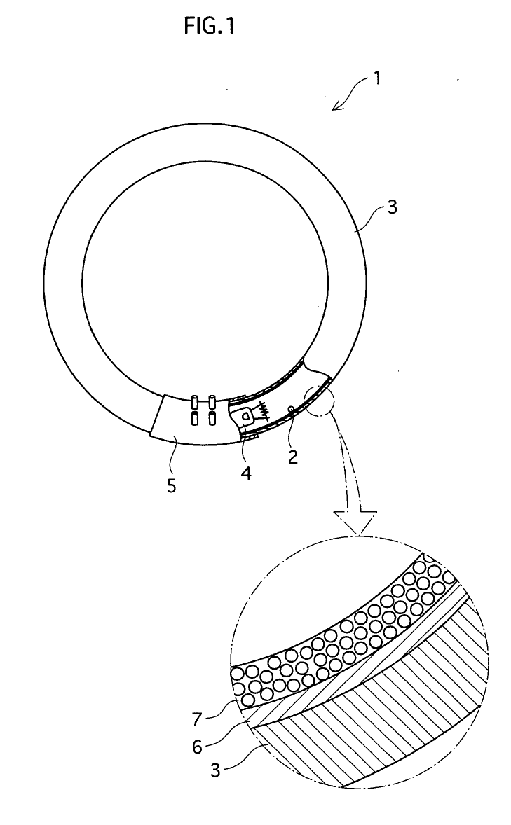

FIG. 1 includes a partially cutaway plan view of a ring shaped fluorescent lamp according to an embodiment of the present invention, and an enlarged schematic cutaway view of the cutaway part. As FIG. 1 shows, the fluorescent lamp 1 according to the embodiment of the present invention is a ring-shaped fluorescent lamp that consumes 30 W of power and encloses therein granular tin amalgam 2 for providing mercury and an argon gas as a rare gas.

The fluorescent lamp 1 includes a ring-shaped glass bulb 3. The glass bulb 3 is made from soda-lime glass. The inside diameter of the glass bulb 3 is 28 mm. The wall thickness of the glass bulb 3 is 1.0 mm. The length in the direction of the bulb axis is 540 mm.

An electrode 4 is placed on each end of the glass bulb 3, and a base 5 is placed so as to cover the both ends.

A protective layer 6 and a phosphor layer 7 are laminated on the inside surface of the glass bulb 3 in order.

The protective layer 6 includes metal oxide particles, and the thickness of the protective layer 6 is 0.8 μm. Silica particles having 50 m²/g of the specific surface (trade name “Aerosil”, manufactured by Nippon Aerosil Co., Ltd.) is used as the metal oxide particles. Here, note that “the thickness of the protective layer 6” in this description means an average thickness of the protective layer 6.

The phosphor layer 7 includes a blue phosphor (BaMg₂Al₁₆O₂₇:Eu²⁺), a green phosphor (LaPO₄:Ce³⁺, Tb³⁺), and a red phosphor (Y₂O₃:Eu³⁺)

(2) Manufacturing Method for Fluorescent Lamp

The glass bulb 3 is manufactured by laminating the protective layer 6 and the phosphor layer 7 on the inside surface of a straight glass tube in order, and bending the glass tube to be in a shape of a ring.

The protective layer 6 is formed by pouring slurry into the glass tube, coating the inside surface of the glass tube with the slurry, and drying the slurry with hot air. The slurry is produced by dispersing silica in a mixture of water and polyethylene oxide.

The phosphor layer 7 is formed by mixing (i) a mixture of the blue phosphor, the green phosphor and the red phosphor and (ii) a binder including fine particles of inorganic oxide (a mixture of calcium oxide, barium oxide, boric, and calcium pyrophosphate), and laminating the resultant mixture on the protective layer 6. After the protective layer 6 and the phosphor layer 7 are formed, the glass tube is to be heated in a baking oven at approximately 550° C. for five minutes for baking the protective layer 6 and the phosphor layer 7.

Next, the protective layer 6 and the phosphor layer 7 in the vicinities of the both ends of the glass tube are removed, and a glass mount including the electrode 4 is sealed to the glass tube. Accordingly, the electrode 4 is sealed to the glass tube as well. After the sealing, to form the glass bulb 3, the glass tube is heated to be 800° C. or higher and formed in a shape of a ring. Then, the tin amalgam 2 and the argon gas are enclosed within the glass bulb 3 via a thin tube that is not illustrated. Finally, the base 5 is placed so as to cover the both ends of the glass bulb. These are the method for manufacturing the ring-shaped fluorescent lamp 1.

(3) Evaluation of Lamp Life

The inventors conducted a life test for evaluating the lamp life of the ring-shaped fluorescent lamp 1 according to the embodiment (Hereinafter called “the lamp of the present invention”). The inventors also used another ring-shaped fluorescent lamp 1 according to the embodiment (hereinafter called “the comparative example”), having the protective layer that is made from alumina (average particle diameter: 0.05 μm, BET specific surface: 100 m²/g). The thickness of the protective layer of the comparative example is 0.5 μm. Note that the comparative example has the same structure as the present invention except for the protective layer 6.

For the life test, the inventors prepared ten lamps of the present invention and ten comparative examples. In the test, 30W of power was applied to each lamp with use of an electronic ballast in a cycle of three hours (lit up for 2.75 hours and turned off for 0.25 hours). The inventors measured the time length until the lighting failure was caused (the life end). For distinguishing the difference among the lamp lives, the amount of the mercury enclosed within each ring-shaped fluorescent lamp was set to be smaller than usual. More specifically, 0.8 mg of mercury was enclosed, which is not more than ⅙ of the usual amount.

As a result, one of the lamps of the present invention caused the lighting failure after a lapse of 6500 hours, and all the others caused the lighting failure within 9500 hours. The average life was 8000 hours. Meanwhile, one of the comparative examples caused the lighting failure after a lapse of 3500 hours, further three caused the lighting failure after a lapse of 4000 hours, further two had caused the lighting failure after a lapse of 5000 hours, and all the others caused the lighting failure within 6500 hours. The average life was 5500 hours.

As described above, the fluorescent lamp 1 according to the embodiment of the present invention has a longer life that is approximately 1.5 times of that of the comparative example. Furthermore, although the amount of the enclosed mercury is ⅙ of the usual amount, the fluorescent lamp 1 according to the embodiment of the present invention has the life that is longer than the rated life of 6000 hours.

(4) Effect that Layer Thickness and Amount of Enclosed Mercury have on Lamp Life

The inventors measured the effect that the layer thickness of the protective layer 6 and the amount of the enclosed mercury have on the lamp life. Based on the above-described ring-shaped fluorescent lamp 1 according to the embodiment, the inventors manufactured a plurality of ring-shaped fluorescent lamps, each having different thickness of the protective layer and different amount of the mercury, and conducted the same test as the above-described life test on the manufactured lamps.

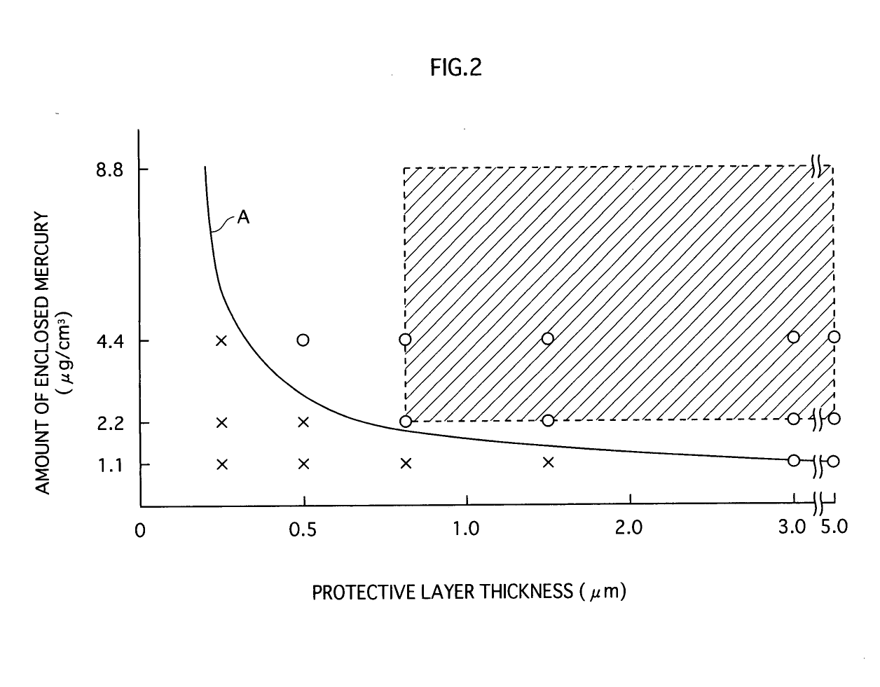

FIG. 2 is a graph showing how the thickness of a protective layer and the amount of the enclosed mercury affect the life of the ring-shaped fluorescent lamp. In this graph, the sign “o” means that all the ten lamps achieved or surpassed the rated life of 6000 hours, and the sign “x” means that there was one or more lamps that did not achieve the rated life.

In the graph of FIG. 2, the curve A is the lower limit of the amount of the mercury, with which all the fluorescent lamps are supposed to achieve or surpass the rated life. In other words, if the amount of the mercury is the value on the curve A or more, the lamp is supposed achieve the rated life, and if the amount of the mercury is less than the value on the curve A, the lamp is supposed to fail to achieve the rated life.

Accordingly, for the fluorescent lamp 1, it is preferable that the amount of the mercury is equal to or more than the value on the curve A. Furthermore, it is particularly preferable that the amount of the mercury and the thickness of the protective layer 6 are in the range shown as a shaded area in FIG. 2. In this area, the layer thickness is in the range from 0.8 μm to 5.0 μm, and the amount of the mercury is in the range from 2.2 μg/cm³ to 8.8 μg/cm³. If this is the case, the fluorescent lamp 1 can achieve the rated life even if the amount of the enclosed mercury is small.

Furthermore, it is preferable that the amount of the enclosed mercury is 4.4 μg/cm³ or less. If this is the case, the amount of the mercury is less than the half of the amount of the mercury enclosed in the conventional fluorescent lamp, and the amount of the mercury is considerably reduced.

Note that the upper limit of the layer thickness of the protective layer 6 is set at 5.0 μm, because if the protective layer 6 is thicker than 5.0 μm, it interferes with the visible light and the luminous flux decreases. Also, the effect of reducing the amount of the mercury reaches a level of saturation when the protective layer is 5.0 μm.

(5) Effect that Thickness of the Protective Layer has on Lamp Life

The inventors measured the effect that the layer thickness of the protective layer 6 has on the lamp life. Based on the above-described ring-shaped fluorescent lamp 1 according to the embodiment, the inventors manufactured a plurality of ring-shaped fluorescent lamps, each having different thickness of the protective layer, and evaluated the characteristics of each manufactured lamp. The inventors used another ring-shaped fluorescent lamp according to the embodiment, having the protective layer that is made from alumina (average particle diameter: 0.05 μm, BET specific surface: 100 m²/g).

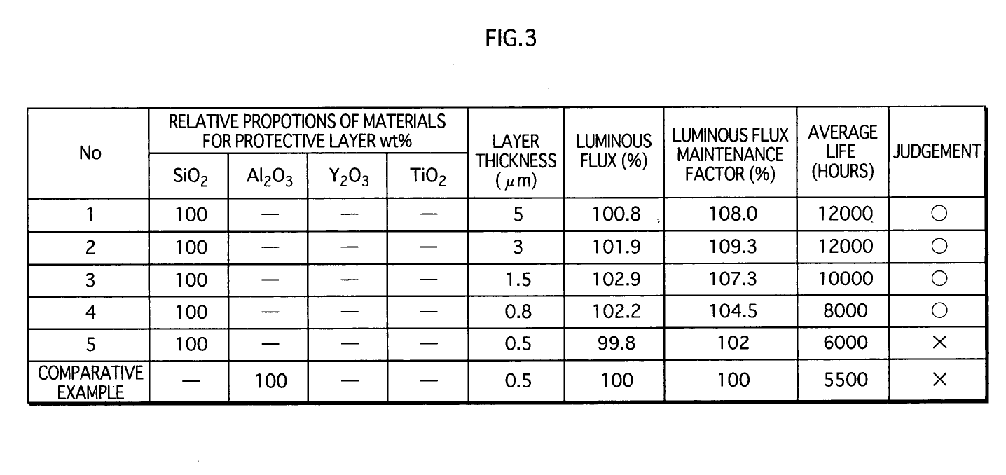

FIG. 3 is a table showing how the thickness of the protective layer 6 affects the life of the lamp. In the fields of “judgement”, the sign “o” means that all the ten lamps achieved or surpassed the rated life of 6000 hours, and the sign “x” means that there was one or more lamps that did not achieve the rated life.

As FIG. 3 shows, the effect of reducing the mercury consumption increases as the thickness of the protective layer 6 increases. Also, the time period for which the lamp can keep on lighting with small amount of the mercury becomes long as the thickness of the protective layer 6 increases. The average life of the comparative example is 5500 hours. This is shorter than the rated life of 6000 hours. Therefore, in the comparative example, the effect of reducing the mercury consumption is not sufficient. Regarding the fluorescent lamps categorized as No. 5, each having approximately 0.5 μm of the layer thickness, the average life is 6000 hours, which is longer than the rated life. However, some lamps included in No. 5 did not achieve the rated life of 6000 hours. Therefore, regarding those lamps, the effect of reducing the mercury consumption is not sufficient. Meanwhile, the average life of the fluorescent lamps whose layer thickness is 0.8 μm or thicker (No. 1-4) is more than 8000 hours, which is more than the rated life. Also, no lamp has the lamp life shorter than 6000 hours. This means that these lamps realize considerable effect of reducing the mercury consumption.

Regarding a fluorescent lamp 1 according to the present invention having the protective layer 6 made from silica, the exfoliation of the phosphor layer 7 did not happen even if the thickness of the protective layer 6 was 5.0 μm. Meanwhile, regarding the protective layer 6 made from alumina, the thickness can not be set at more than 1.0 μm, because of the exfoliation of the phosphor layer 7.

Regarding the fluorescent lamp 1 according to the embodiment of the present invention, the luminous flux and the luminous flux maintenance factor did not decrease although the thickness of the protective layer 6 was thickened. Instead, contrary to expectation, luminous flux and the luminous flux maintenance factor increased. The inventors believe that this is because although the protective layer 6 blocks visible light and the luminous flux decreases, the protective layer 6 reflects ultraviolet rays and the phosphor layer 7 can use ultraviolet rays more efficiently, and therefore the luminous flux increases.

Based on the above-described results, it is preferable that the thickness of the protective layer 6 of the fluorescent lamp 1 according to the present invention is equal to or more than 0.8 μm. As the thickness is in this range, the mercury consumption can be suppressed.

(6) Effect that Relative Proportion of Silica Included in Protective Layer Has on Lamp Life

The inventors measured the effect that the relative proportion of silica included in the protective layer 6 has on the lamp life. Based on the above-described ring-shaped fluorescent lamp 1 according to the embodiment, the inventors manufactured a plurality of ring-shaped fluorescent lamps, in each of which the relative proportion of silica included in the protective layer is different, and evaluated the characteristics of each manufactured lamps.

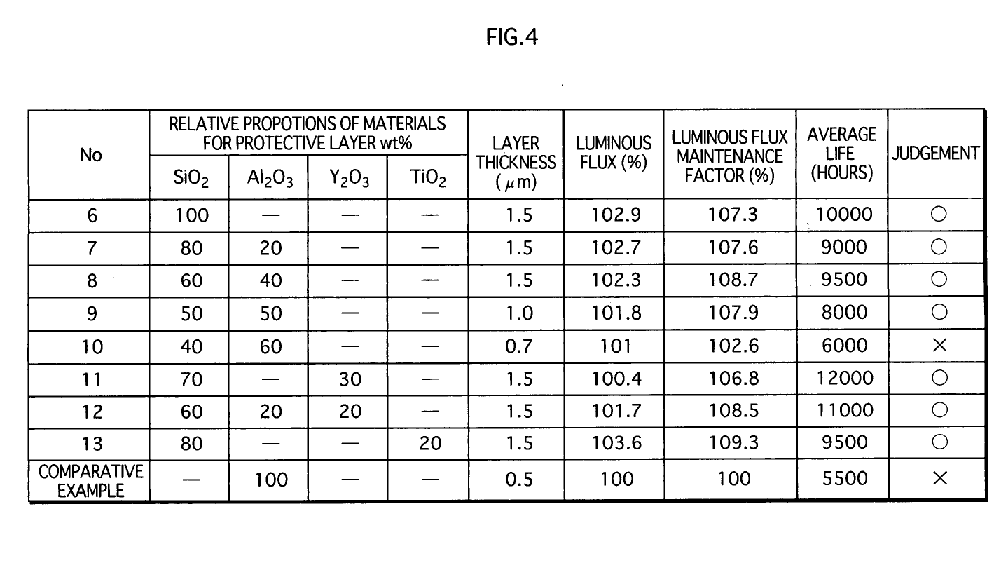

FIG. 4 is a table showing how the relative proportion of silica included in the protective layer 6 affects the characteristics of the lamp. The “judgement” is performed based on the same criterion as that in FIG. 3.

As FIG. 4 shows, regarding the fluorescent lamps in each of which the relative proportion of silica is 40% (No. 10), the luminous flux maintenance factor is lower and the lamp life is shorter than the other fluorescent lamps (No. 6 to 9 and No. 11 to 13), and some lamps included in No. 10 caused the lighting failure before the rated life (represented by “x” in the field of “judgement”). This is because the phosphor layer was readily exfoliated due to the low relative proportion of silica, and it was impossible to set the thickness of the protective layer at more than 0.7 μm. Also regarding the fluorescent lamps in which the relative proportion of silica is 40% (No. 10), the thickness of the phosphor layer became uneven and the glass was irradiated with ultraviolet rays and stained, because the protective layer 6 was exfoliated. Meanwhile, the fluorescent lamps which the relative proportion of silica is equal to or more than 50% (No. 6 to 9, and No. 11 to 13), the luminous flux maintenance factor did not become low, the average life did not become short, the glass was not stained, and the all the lamps achieved the rated life. Therefore, it is preferable that the relative proportion of silica is equal to or more than 50%.

In the case where the relative proportion of silica is equal to or more than 50%, if other inorganic oxides are added, it is possible to gain the characteristic of the inorganic oxides while keeping the characteristic of the protective layer 6 made from silica.

For instance, each of fluorescent lamps having a protective layer into which alumina is added (No. 6 to 9) has higher luminous flux and higher luminous flux maintenance factor than the comparative example, and the luminous flux and the luminous flux maintenance factor increases as the relative proportion of alumina increases. In this way, it is possible to improve the luminous flux maintenance factor while maintaining the effect of reducing the mercury consumption by adding an appropriate amount of alumina into the protective layer 6.

Also, each of fluorescent lamps having a protective layer 6 into which yttria is added (No. 11) has longer life than the comparative example and the fluorescent lamp having a protective layer that includes only silica. This is because yttria is an inorganic oxide that does not readily absorb mercury, and the mercury consumption is reduced more. Furthermore, each of fluorescent lamps having a protective layer into which yttria and alumina is added (No. 12) has higher luminous flux maintenance factor in addition to longer life. This means that the effect of the yttria for reducing the mercury consumption, and the effect of alumina for improving the luminous flux maintenance factor are both realized. Such effects can not be gained by adding only yttria or only alumina.

Furthermore, a fluorescent lamp having a protective layer 6 into which titania is added (No. 13) has higher luminous flux and higher luminous flux maintenance factor than the conventional lamp. The inventors believe that this is because the added titania, which has effect of blocking ultraviolet rays, is added into the protective layer 6 and improves the effect of reflecting ultraviolet rays, and the phosphor layer 7 can use ultraviolet rays more efficiently. The inventors also believe that the protective layer blocks ultraviolet rays more effectively, and the glass becomes resistant against the deterioration caused by ultraviolet rays.

As described above, it is possible to maintain the effect of reducing the mercury consumption by adding 50% or more silica into the protective layer, and it is also possible to improve the characteristics of the lamp, such as the lamp life, the luminous flux, and the luminous flux maintenance factor, by further adding inorganic oxides except for silica into the protective layer 6.

(7) Effect that BET Specific Surface of Silica has on Formation of Protective Layer

The inventors measured the effect that the BET specific surface of silica has on the formation of the protective layer 6. The inventors formed a plurality of protective layers, each having different BET specific surface, and evaluated whether the thickness of each protective layer is even.

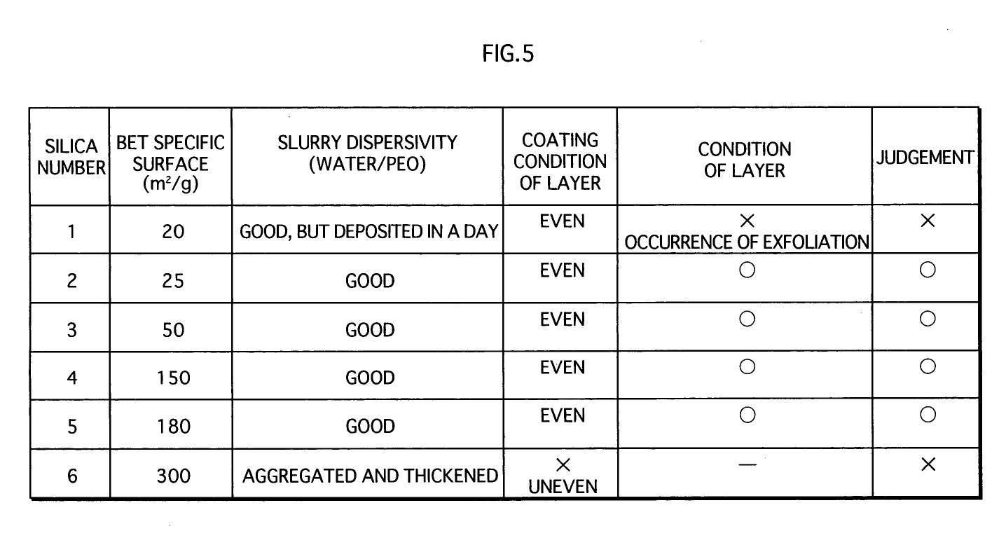

FIG. 5 is a table showing how the BET specific surface affects characteristics of the lamp. As FIG. 5 shows, silica having 20 m²/g of BET specific surface was deposited in a few hours in slurry, and therefore it is not suitable for the fluorescent lamp 1 according to the present invention. Meanwhile, silica having 300 m²/g of BET specific surface is very expensive and it is difficult to handle the silica with in safety because of its low wind-pressure resistance. Therefore, it is also unsuitable for the fluorescent lamp 1 according to the present invention.

The inventors found that the silica having 25 m²/g to 180 m²/g of BET specific surface is suitable for the fluorescent lamp according to the present invention, because the test results of the dispersivity in a common dispersant, the evenness of the layer thickness, and the resistance of the layer during the glass processing are all favorable.

The silica having 25 m²/g to 180 m²/g of BET specific surface disperses in the dispersant stably, and it is easy to modulate the concentration of the silica in the slurry. Therefore, it is possible to form the layer using the silica so that the layer thickness is 1 μm to 5 μm. Also, by modulating the loading of the polyethylene oxide used as the dispersant, it is possible to give fineness and heat-resistance.

In stead of the polyethylene oxide, water-soluble polymers, such as polyvinyl alcohol and polyvinyl pyrrolidone may be used as the dispersant generally.

The inventors also found that the mercury consumption of the protective layer can be reduced in the case of using butanol or butyl acetate as the solvent of the dispersant, and the case of adding ammonia or acetic acid to the dispersant and modulating its pH. Moreover, the protective layer 6 according to the present invention can be formed through the use of change in pH caused by acid, alkali or salt, or the mixing effect of other inorganic oxides.

(8) Modifications of Fluorescent Lamp

1. Fluorescent Lamp having Bent Glass Bulb

The fluorescent lamp according to the present invention is not limited to the ring-shaped fluorescent lamp 1, but may be a fluorescent lamp having a bent glass bulb, such as a twin tube fluorescent lamp and a double-ring shaped fluorescent lamp. Note that the “bent glass bulb” in this description means a glass bulb formed by connecting or bending so that the glass bulb has a non-straight shape.

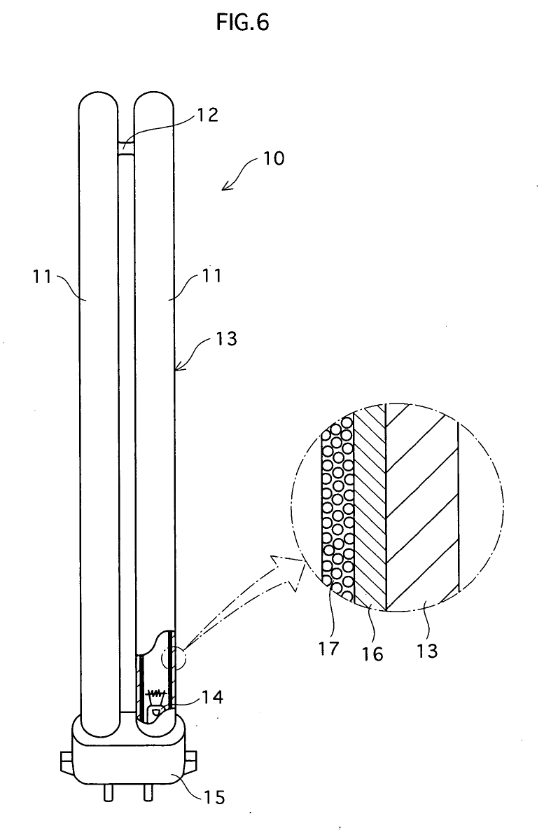

FIG. 6 is a partially cutaway plan view of a twin tube fluorescent lamp according to a modification of the present invention, and an enlarged schematic cutaway view of the cutaway part of the cutaway part. The twin tube fluorescent lamp 10 shown in FIG. 6 (power consumption: 36 W) has a glass bulb 13 that includes substantially U-shaped discharge path that is structured by two straight glass tubes 11 whose respective one ends are connected to each other by a bridge 12.

An electrode 14 is placed at each end of the glass bulb 13. A base 15 is placed so as to cover the both ends of the glass bulb 13. The inside diameter of each straight glass tube 11 is 18 mm, and the length of the discharge path is 780 mm.

A protective layer 16 and a phosphor layer 17 are laminated on the inside surface of the glass bulb 13 in order. Tin amalgam and an argon gas as a discharge gas, which are not illustrated, are enclosed within the glass bulb 13.

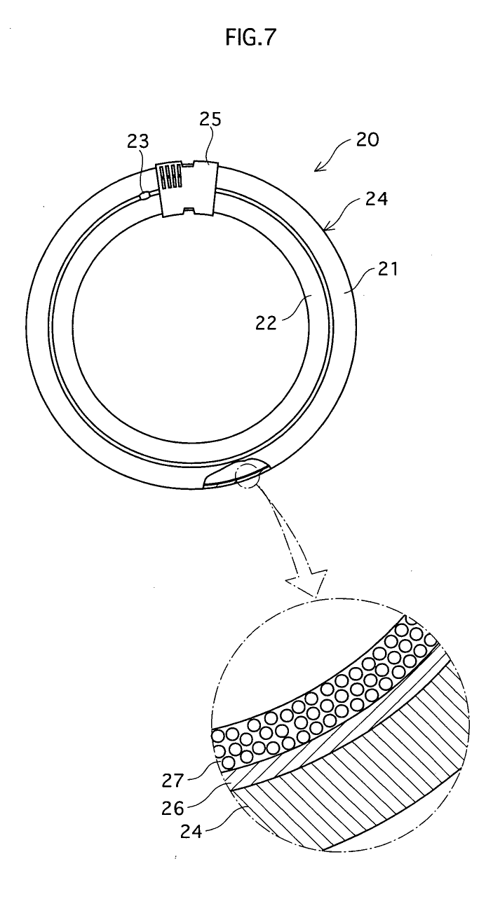

FIG. 7 is a partially cutaway plan view of a double ring-shaped fluorescent lamp according to a modification of the present invention, and an enlarged schematic cutaway view of the cut away part. The double ring-shaped fluorescent lamp shown in FIG. 7 (power consumption: 36 W) has a double ring-shaped glass bulb 24 that includes a pair of ring-shaped glass tubes 21 and 22, each having a different diameter and whose respective one ends are connected to each other by a bridge 23. The inside diameter of each of glass tubes 21 and 22 is 17 mm, and the length of the discharge path is 2200 mm.

An electrode, which is not illustrated, is placed at each of the other ends of the glass tubes 21 and 22, where is on the side not connected by the bridge 23. A base 25 is placed so as to cover both pairs of the ends.

A protective layer 26 and a phosphor layer 27 are laminated on the inside surface of the glass bulb 23 in order. Tin amalgam and an argon gas as a discharge gas, which are not illustrated, are enclosed within the glass bulb 23.

The inventors conducted the same life test as conducted on the above-described ring-shaped fluorescent lamp 1 on the twin tube fluorescent lamp 10 and the double ring-shaped fluorescent lamp 20. Regarding each of the protective layers 16 and 26, the inventors measured the effect that the layer thickness and the amount of mercury have on the lamp life. The result is the same as that for the ring-shaped fluorescent lamp 1.

2.Straight Tube Fluorescent Lamp

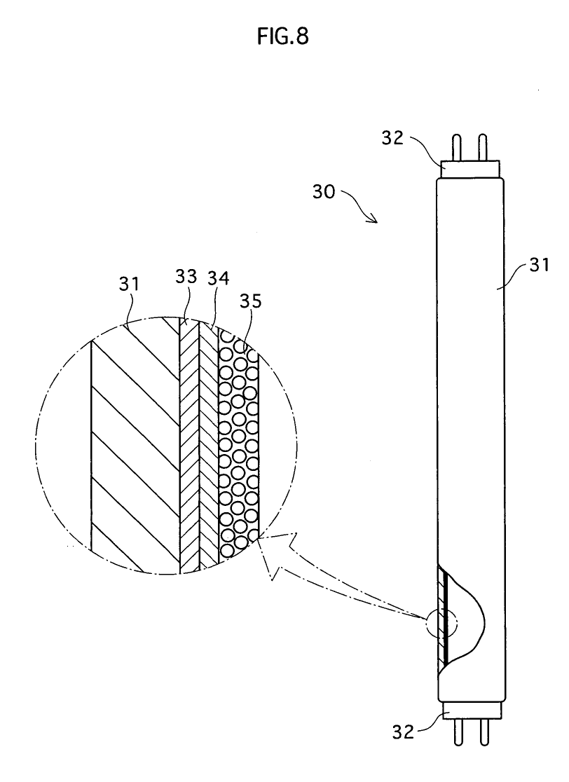

The fluorescent lamp according to the present invention is not limited to a fluorescent lamp having a bent glass bulb, but may be a straight tube fluorescent lamp as shown in FIG. 8. A straight tube fluorescent lamp 30 shown in FIG. 8 is a rapid-start fluorescent lamp (power consumption: 40W), whose rated life is 12000 hours, and the lamp length is 1200 mm.

The inside diameter of the tube is 28.0 mm. An electrode, which is not illustrated, is placed at each end of the glass bulb 31. Bases 32 are respectively placed so as to cover the both ends of the glass bulb 31. A conductive layer 33, a protective layer 34 and a phosphor layer 35 are laminated on the inside surface of the glass bulb 31 in order. Tin amalgam and an argon gas as a discharge gas, which are not illustrated, are enclosed within the glass bulb 31.

Generally, the straight tube fluorescent lamp 30 is formed without bending the glass bulb 31. Therefore, the heat load on the glass is low and the amount of the alkali metal flowed out from the glass is small. Accordingly, the mercury consumption of the straight tube fluorescent lamp 30 is smaller than the fluorescent lamp having the bent glass tube, and the straight tube fluorescent lamp 30 can achieve the rated life with smaller amount of mercury.

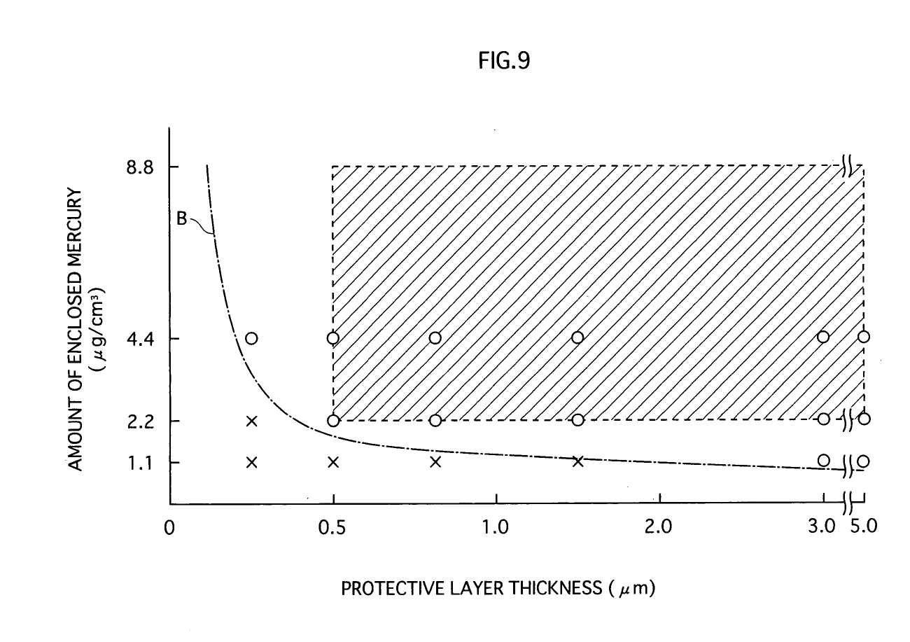

The inventors conducted the same life test as conducted on the above-described ring-shaped fluorescent lamp 1 on a straight tube fluorescent lamps 30. Regarding the protective layers 34, the inventors measured the effect that the layer thickness and the amount of mercury have on the lamp life. FIG. 9 shows the result. In the graph, the sign “o” means that all the ten lamps achieved the rated life of 6000 hours, and the sign “x” means that there was one or more lamps that did not achieve the rated life.

Even if the amount of mercury enclosed within the glass bulb is only 2.2 mg, the straight tube fluorescent lamp 30 achieves the rated life as long as the thickness of the protective layer 34 is 0.5 μm or thicker. However, in the case where the amount of the enclosed mercury is 1.1 mg, the rated life can be achieved only when the thickness of the protective layer 34 is 3.0 μm or thicker. In the graph of FIG. 9, the curve B is the lower limit of the amount of the mercury, with which all the fluorescent lamps are supposed to achieve or surpass the rated life.

Accordingly, for the straight tube fluorescent lamp 30, it is preferable that the amount of the mercury is larger than the value on the curve B. Furthermore, it is particularly preferable that the amount of the mercury and the layer thickness are in the range shown as a shaded area in FIG. 9. In this area, the layer thickness is in the range from 0.5 μm to 5.0 μm, and the amount of the mercury is in the range from 2.2 μg/cm³ to 8.8 μg/cm³. If this is the case, the straight tube fluorescent lamp can keep the rated life even if the amount of the enclosed mercury is small. Furthermore, it is preferable that the amount of the enclosed mercury is 4.4 μg/cm³ or less. If this is the case, the amount of the mercury is smaller than the half of the amount of the mercury enclosed within the conventional fluorescent lamp, and the amount of the mercury is considerably reduced.

Conventionally, in the rapid-start fluorescent lamp 30, black spots are often caused by the mercury that attached to the inside surface during the lighting, and this deteriorates the appearance of the fluorescent lamp 30. However, the structure of the present invention reduces the occurrence of the black spots, prevents the deterioration of the appearance and improves the luminous flux maintenance factor.

3. Fluorescent Lamp having Glass Bulb with Small Inside Diameter

Generally, the mercury consumption of the fluorescent lamp becomes large in the case where the lamp load (the emission power per the inside surface of the lamp) is high or the temperature during the lighting is high. Therefore, in the fluorescent lamp having glass bulb with small inside diameter, the mercury is readily absorbed to the glass. Accordingly, the mercury consumption of such a fluorescent lamp is larger than a fluorescent lamp having glass bulb with large diameter. Regarding the fluorescent lamp having a glass bulb with a small inside diameter, the inventors measured the effect that the layer thickness and the amount of mercury have on the lamp life.

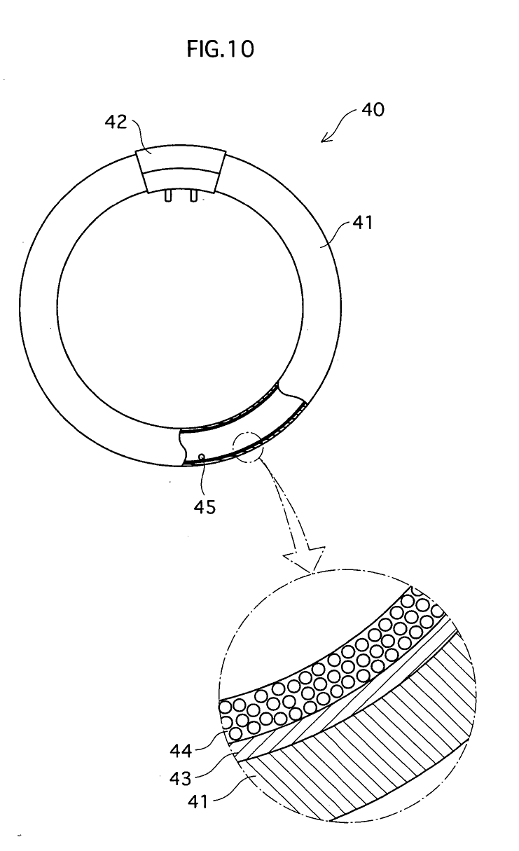

A fluorescent lamp 40 shown in FIG. 10 (power consumption: 40 W) is a slim ring-shaped fluorescent lamp including a ring-shaped glass bulb 41. The inside diameter of the glass tube is 14.0 mm, and the length in the direction of the glass tube axis is 850 mm.

An electrode is placed at each end of the glass bulb 41. A base 42 is placed so as to cover the both ends of the glass bulb 41. A protective layer 43 and a phosphor layer 44 are laminated on the inside surface of the glass bulb 41 in order. Tin amalgam and an argon gas as a discharge gas, which are not illustrated, are enclosed within the glass bulb 41.

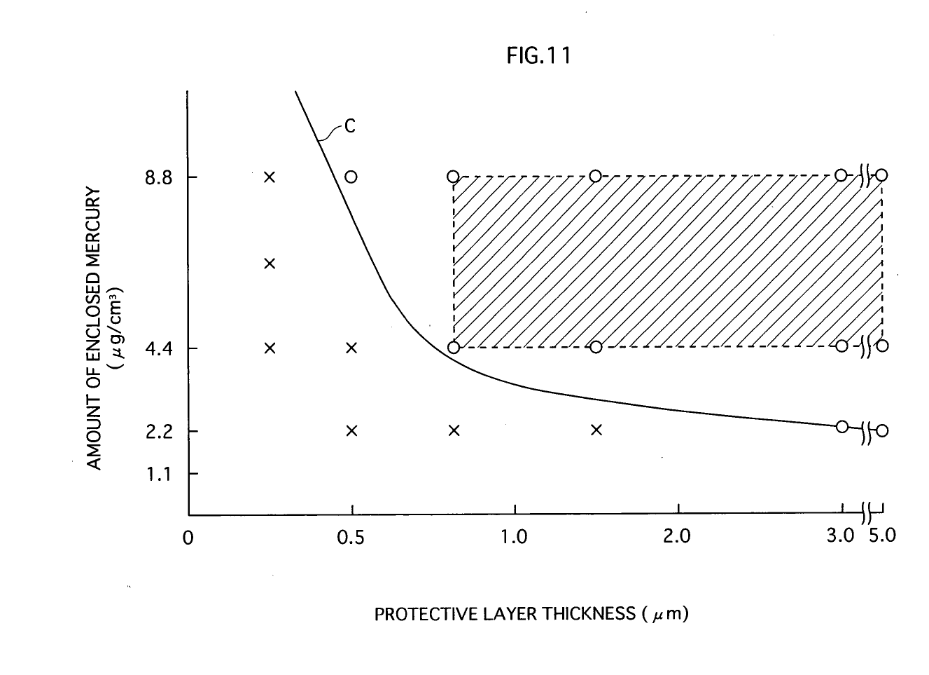

The inventors conducted the same life test as conducted on the above-described ring-shaped fluorescent lamp 1 on the above-described fluorescent lamp 40. FIG. 11 shows how the thickness of the protective layer 43 of the fluorescent lamp and the amount of the mercury affect the lamp life. The inside diameter of the fluorescent lamp is less than 17 mm. In the graph of FIG. 11, the sign “o” means that all the ten lamps achieved the rated life of 6000 hours, and the sign “x” means that there was one or more lamps that did not achieved the rated life.

For the above-described fluorescent lamp 40, it is preferable that the amount of the mercury is equal to or more than the value on the curve C. Furthermore, it is particularly preferable that the amount of the mercury and the layer thickness are in the range shown as the shaded area in FIG. 11. In this area, the layer thickness is in the range from 0.8 μm to 5.0 μm, and the amount of the mercury is in the range from 4.4 μg/cm³ to 8.8 μg/cm³. If this is the case, the fluorescent lamp 40 can achieve the rated life even if the amount of the enclosed mercury is small.

The inventors conducted the same life test as conducted on the above-described ring-shaped fluorescent lamp 1 on a twin Hf fluorescent lamp, which is in the same type as the twin fluorescent lamp shown in FIG. 6. Regarding this twin Hf fluorescent lamp (not illustrated), the power consumption is 32 W and the inside diameter of the glass bulb is 15.5 mm. As a result of the test, the inventors found that it is preferable that the thickness of the protective layer 43 and the amount of the mercury is in the range shown in FIG. 10, which is the same as the range for the ring-shaped fluorescent lamp 40.

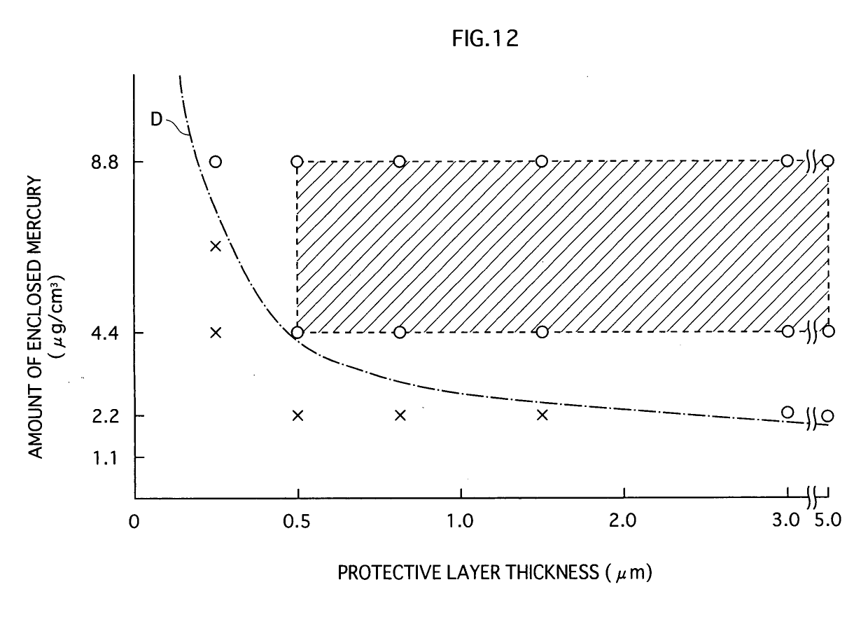

The inventors also conducted the same life test on a straight tube fluorescent lamp, which is in the same type as the straight tube fluorescent lamp 30 shown in FIG. 8. Regarding this straight tube fluorescent lamp (not illustrated), the power consumption is 54 W, the inside diameter of the glass bulb is 14.0 mm and the length of the lamp is 1150 mm. FIG. 12 shows the test result. In the graph of FIG. 12, the sign “o” means that all the ten lamps achieved the rated life of 6000 hours, and the sign “x” means that there was one or more lamps that did not achieve the rated life. For the above-described fluorescent lamp, it is preferable that the amount of the mercury is equal to or more than the value on the curve D. Furthermore, it is particularly preferable that the amount of the mercury and the layer thickness are in the range shown as the shaded area in FIG. 12. In this area, the layer thickness of the protective layer 43 is in the range from 0.5 μm to 5.0 μm, and the amount of the mercury is in the range from 2.2 μg/cm³ to 8.8 μg/cm³. If this is the case, the fluorescent lamp can achieve the rated life even if the amount of the enclosed mercury is small.

4. Electrodeless Fluorescent Lamp

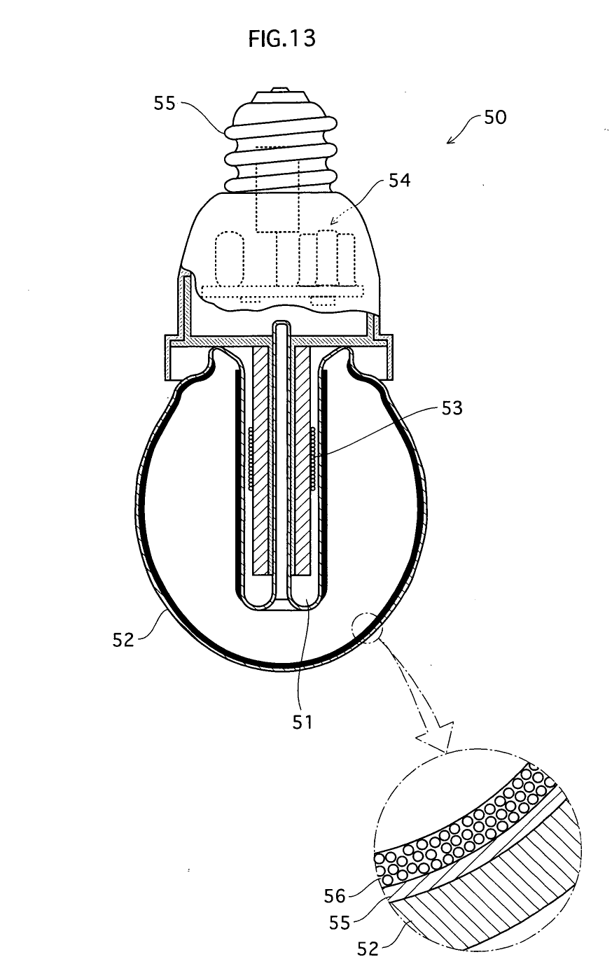

The fluorescent lamp according to the present invention may be an electrodeless fluorescent lamp in which an excitation coil generates an induced magnetic field for inputting power into the lamp. An electrodeless fluorescent lamp 50 (power consumption 20 W) shown in FIG. 13 includes a glass bulb 52 having a depression 51, an excitation coil 53 that is disposed in the depression 51 and generates an induced magnetic field in the glass bulb 52, a circuit 54 used for applying high frequency alternating current to the excitation coil 53, and a base 55 used for feeding the circuit 54.

A protective layer 55 including metal oxide particles and a phosphor layer 56 is laminated on the inside surface of the glass bulb 52 in order. Zinc tin amalgam and an argon gas as a discharge gas, which are not illustrated, are enclosed within the glass bulb 52. Note that the protective layer 55 does not necessarily include metal oxide particles.

The electrodeless fluorescent lamp 50 does not consume the emitter and can be used semipermanently, and therefore it has little adverse effect on the environment. However, the fluorescent lamp 50 includes mercury vapor inside. The mercury is consumed, and this causes the lighting failure. Therefore, for realizing a long life, it is demanded to reduce the mercury consumption just like the case of usual fluorescent lamps. The structure of the present invention meets the demand.

(9) Other Modifications

1. Protective Layer

The protective layer according to the present invention is formed by metal oxide particles. As long as 50 wt % or more of silica is included in the metal oxide, other metal oxides may be used. For instance, yttria, titania, alumina, calcium oxide, barium oxide, magnesium oxide, cerium oxide, zirconia, and zinc oxide and so on are low-cost and preferable. Metal oxides including elements selected from manganese, europium, vanadium, phosphorus, sulfur, boron,,antimony, terbium, gallium, iron, silver, copper, lead, zinc, cadmium, gadolinium, lanthanum, strontium, tungsten, thallium and so on (not only mono-metal oxide, but also multi-metal oxide) are high-cost, but preferable because they improve the luminance.

As long as 50 wt % or more of silica is included in the metal oxide, the above materials do not affect the bulk density and the limit of the thickness of the protective layer very much, and effectively reduce the mercury consumption.

For forming the protective layer according to the present invention, petroleum solvent, such as butyl acetate, xylene, methanol, ethanol, butanol, benzene, toluene, pentane, dioxane, and hexane may be used as the slurry solvent. Recently, the use of organic solvent has been restricted. Accordingly, eco-friendly coating materials using water is now the preferred choice. Therefore, a mixture of water and water-soluble dispersant (e.g. polyethylene oxide, polyvinyl alcohol, and polyvinyl pyrrolidone) is most suitable.

Furthermore, the protective layer may be formed on the inside surface of the glass bulb by dispersing silica and so on with use of a liquid under pressure, such as ethane, methane, nitrogen, carbon monoxide, and oxygen, as dispersant, and rapidly ejecting the silica and so on from the nozzle to the inside surface. The protective layer formed by this method has low bulk density and is evenly applied on the surface, and therefore effectively reduce the mercury consumption. Also, such a protective layer is highly resistant against shrinking and swelling caused by the subsequent bending process. Therefore, the protective layer can be thickened.

2. Phosphor

Common phosphors can be used for the phosphor layer according to the present invention. However, atomized or spherically formed phosphors may be used instead. If this is the case, the exfoliation of the phosphor layer can be prevented, because the bulk density of the phosphor layer becomes comparatively high. Also, it is preferable to use a phosphor called a nanoparticle phosphor, whose particle size is from a few nanometers to a few hundred nanometers and which has been attracting widespread attentions in recent years. If the protective layer according to the present invention is coated with such a phosphor, the phosphor is mixed with the protective layer material and keeps a high luminous efficiency. The phosphor layer can be formed without a problem, such as the exfoliation.

Furthermore, it is preferable to add a binder into the phosphor to prevent the exfoliation of the phosphor layer. Increasing the amount of the binder makes the phosphor layer more resistant against the exfoliation. As the binder, inorganic oxides, such as alumina, yttria, and silica may be used instead of the material described in the embodiment.

3. Glass

Soda-lime glass with high workability is suitable as the glass according to the present invention. However, borosilicate glass, alumina glass or the like may be used instead. If this is the case, the workability is lower than the soda-lime glass, but the mercury consumption is supposed to be reduced, because the borosilicate glass and the alumina glass include only a small amount of alkaline component.

If the soda-lime glass is used, it is advisable to perform an acid cleaning, a steam cleaning or the like, because the mercury consumption can be further reduced by removing soda that exists on the inside surface of the glass bulb.

4. Mercury

There are several methods used for enclosing mercury in the fluorescent lamp according to the present invention. For instance, a method of putting drops of mercury with a dropper, a method of enclosing mercury as an amalgam with zinc, tin or the like, a method of enclosing iron-zinc-copper-mercury alloy or titan amalgam with a dispenser, and a method of enclosing a capsule of glass that encloses mercury. Also, amalgam including bismuth, indium, lead and tin, which can keep low vapor pressure of mercury at a high temperature (50-80° C.), may be used for reducing the amount of the mercury.

If the amount of the mercury enclosed within the fluorescent lamp is reduced, it is required to enclose a minute amount of mercury without variations. By the method of enclosing mercury as an amalgam, it is easy to control the enclosing amount. Also, the method of enclosing the capsule prevents that a product in which mercury is failed to be enclosed comes onto the market, because in this method, it is obvious whether the capsule exists or not.

The fluorescent lamp according to the present invention can be used for a mercury discharge lamp that uses mercury. The fluorescent lamp according to the present invention is particularly suitable for a fluorescent lamp having a bent glass bulb.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A fluorescent lamp, comprising:
a glass bulb;
mercury that is enclosed within the glass bulb, an amount of the mercury being from 2.2 μg/cm³ to 8.8 μg/cm³;
a rare gas that is enclosed within the glass bulb;
an electrode that is attached to the glass bulb;
a protective layer that is formed on an inside surface of the glass bulb, and includes metal oxide particles and at least 50 wt % of silica, a thickness of the protective layer being from 0.5 μm to 5.0 μm; and
a phosphor layer that is formed over the protective layer.

2. The fluorescent lamp of claim 1, wherein
the glass bulb has a bent shape, and
the thickness of the protective layer is 0.8 μm or more.

3. The fluorescent lamp of claim 1, wherein
an inside diameter of the glass bulb is less than 17 mm, and
at least 4.4 μg/cm³ of the mercury is enclosed within the glass bulb.

4. The fluorescent lamp of claim 2, wherein
an inside diameter of the glass bulb is less than 17 mm, and
at least 4.4 μg/cm³ of the mercury is enclosed within the glass bulb.

5. The fluorescent lamp of claim 1, wherein
the protective layer includes yttria.

6. The fluorescent lamp of claim 4, wherein
the protective layer includes yttria.

7. The fluorescent lamp of claim 1, wherein
a BET specific surface of the silica is from 25 m²/g to 180 m²/g.

8. The fluorescent lamp of claim 6, wherein
a BET specific surface of the silica is from 25 m²/g to 180 m²/g.

9. A fluorescent lamp, comprising:
a glass bulb;
mercury that is enclosed within the glass bulb, an amount of the mercury being from 2.2 μg/cm³ to 8.8 μg/cm³;
a rare gas that is enclosed within the glass bulb;
a protective layer that is formed on an inside surface of the glass bulb and includes at least 50 wt % of silica, a thickness of the protective layer being from 0.5 μm to 5.0 μm;
a phosphor layer that is formed over the protective layer; and
an excitation coil operable to generate an induced magnetic field within the glass bulb.

10. The fluorescent lamp of claim 9, wherein
the protective layer includes yttria.

11. The fluorescent lamp of claim 9, wherein
a BET specific surface of the silica is from 25 m²/g to 180 m²/g.

12. The fluorescent lamp of claim 10, wherein
a BET specific surface of the silica is from 25 m²/g to 180 m²/g.
